(19) United States
(12) Patent Application Publication
(10) Pub. No.: US 2006/0045683 A1
(43) Pub. Date: Mar. 2, 2006

(54) Hydraulic vehicle lift dolly

(76) Inventors: Wang Huiming, Jiashan (CN); Zaho Lei, Arcadia, CA (US)

Correspondence Address: National IP Rights Center, LLC, Suite 400, 550 Township Line Road, Blue Bell, PA, 19422, US

(21) Appl. No.: 10/930,055

(22) Filed: Aug. 30, 2004

(51) Int. Cl. B60B 29/00

(52) U.S. Cl. 414/426

(57) ABSTRACT

An apparatus that jacks and, thereafter, dollies a vehicle wheel assembly while the assembly is affixed to the vehicle, the assembly including a pneumatic tire, a wheel and an axle, the apparatus comprising: a framework including a body section having a first member and a second member, the first and second body section members being movable relative to one another, a first arm member connected to the first body member, and a second arm member connected to the body section second member; transport wheels for rendering the apparatus movable; rollers affixed to the arms for interacting with the wheel assembly, an hydraulic actuator connected to the framework and which cooperates with the arms such that when the hydraulic actuator means is activated, the rollers are forced into contact with the pneumatic tire causing the tire to ride over the rollers and lift the wheel assembly.

### FIELD OF THE INVENTION

This invention is for jacking and dollying a vehicle wheel assembly while the assembly remains affixed to the vehicle using a novel hydraulic activation system.

### BACKGROUND OF THE INVENTION

The movement of conventional vehicles in confined spaces is difficult and inefficient at best. Because many new cars and trucks are equipped with front wheel steering, a series of repeated backward and forward maneuvers is required to park them in limited spaces, such as those found in repair garages or body shops. Further, on those occasions when size and geometry of the space is particularly limited, it may be impossible to position the vehicle as desired at all.

In the case of a garage or body shop, providing sufficient space to accommodate vehicles of all types may require servicing fewer vehicles, making the facility; i.e., floor space, larger, or some combination of the two. Accommodating fewer vehicles and providing larger space are costly. They entail either loss of operating revenue due to the reduced number of vehicles served, or additional capital outlay for construction of increased space. Long term parking and storage facilities have similar problems.

Particularly, the vehicle front wheels are constrained to turn together, and only through a limited angle, while the back wheels can not be turned at all. However, if each of the vehicle wheels were free to swivel 360 degrees about its vertical axis; e.g., like a dolly caster, vehicle movement limitations would be eliminated. In fact, if the vehicle were placed on a dolly, the independent 360 degree swivel action afforded by the dolly casters would permit the vehicle to be moved at right angles, rotationally or through shallow arcuate paths as desired.

The complexity of providing a suitable dolly, and the loading and unloading of a vehicle to and from it, however, is not insignificant. To be successful, the dolly must be capable of sustaining the vehicle's size and weight, and, as a result, would require costly and bulky construction. Further, the dolly must be able to get the vehicle from the ground onto the dolly and from the dolly back to the ground again.

An alternative to lifting the entire vehicle onto a single dolly would be to use individual jacking and dolly units placed at each vehicle wheel assembly. Use of individual units capable of both lifting the wheel assembly and carrying it, while affixed, would permit the wheel assembly to be raised from the ground, and once raised, Further, the use of individual units could provide substantial cost savings. The work required of individual units would be significantly less than that of a single large dolly. With individual units, only approximately a quarter of the vehicle's weight would have to be sustained, and none of its size; i.e., spanning between wheels would be eliminated. Accordingly, the bulk, complexity and cost of individual dolly units would be substantially less than that of a single dolly. Further, the need for a complex and costly vehicle hoist or jack would be eliminated.

But even in the case of individual units, problems remain. In particular, if an individual unit is to be effective, not only should it combine, in a single apparatus, the ability to both lift the wheel assembly from the ground and, thereafter, transport it, but also, it should be flexible enough to accommodate the wide variety of vehicle wheel assembly sizes commonly found today. Further, because it is not uncommon for the tire of a wheel assembly to be flat, particularly in a garage or body shop, the unit must be able to lift the wheel assembly whether the tire is inflated or deflated. Still further, to be commercially attractive, the unit should be simply and quickly manipulated by a single operator using hydraulic actuation system. These results must be achieved with a structure whose bulk does not interfere with vehicle movement or whose cost does not prohibit use.

For example, E. R. Carruthers in U.S. Pat. No. 2,380,415, issued Jul. 31, 1945, proposes a tire and wheel dolly suitable for handling truck dual rear wheel. In accordance with the Carruthers design, a separate jack is needed to lift the truck axle, wheel and tires from the ground so that his apparatus can be rolled beneath. Thereafter, cradles provided on the apparatus are brought beneath and against the tires by means of a crank and screw mechanism to lift the tires and wheels from the axle. Accordingly, the Carruthers apparatus requires the undesirable step and equipment for separately lifting the wheel assembly before the apparatus can be used. Additionally, because of its design, the Carruthers apparatus would not be suitable for lifting deflated tires, the action and range of motion of the cradles being dissipated in deforming the deflated tire. Further, the Carruthers design is not susceptible of quick, single action manipulation.

Another proposed tire and wheel dolly is described by W. F. Gemmill in his U.S. Pat. No. 2,217,898, issued Oct. 15, 1940. Like the Carruthers apparatus, the Gemmill dolly also requires a separate jack for initially lifting a truck axle, wheels and tires. Once the wheel assembly has been raised, arms on the apparatus may be caused to engage the truck tires to lift them together with their wheels from the truck's axle. Accordingly, as in the case of Carruthers design, the Gemmill dolly requires the use of a separate jack with its associated shortcomings. Further, due to the nature of its jacking arrangement, the Gemmill apparatus has an especially bulky and complex mechanism, and would, therefore, not be suited for unencumbered movement of the vehicle or quick action.

Other and similar examples of tire and wheel dollies are found in U.S. Pat. Nos. 1,967,119; 2,170,607; 2,386,516; 2,410,902 and 3,836,027. However, as in the case of the Carruthers and Gemmill dollies, separate jacks are relied upon to lift the vehicle axle. Additionally, the bulk, complexity and nature of operation of these dollies would encumber vehicle movement and not be suited for simple and quick operation.

A jack has, however, been proposed by R. L. Foringer in U.S. Pat. No. 2,332,443 issued Oct. 19, 1943, which is capable of lifting and dollying circular bodies. But, the Foringer jack, as described, is designed for lifting rigid objects such as large metal tanks. The jack features rollers mounted on arms, the arms being coupled by a threaded shaft and nut assembly. By manipulating a pawl and handle which extends from the device, the nut assembly draws the arms and associated rollers against the tank side walls causing the tank to lift. While the Foringer jack would appear capable of lifting an inflated tire, it, however, would not be capable of lifting a deflated tire; the action of drawing the rollers against the tread being dissipated in the deformation of the deflated tire. Further, the pawl and handle arrangement are unsuited for providing quick, single action operation, and would encumber movement of the vehicle.

U.S. Pat. Nos. 4,690,605 and 4,854,803 illustrate embodiments of the a wheel jacking system in which complex lever or ratchet mechanisms are used to jack up the tire of a vehicle. While an improvement over previous systems, these systems incorporate an apparatus requiring mechanical inter-activity. These systems are dangerous and require the exertion of considerable physical strength and/or the use of mechanical members to lift the vehicle, such as levers and ratchets.

The present invention is directed to a hydraulic actuated system for jacking up a single pneumatic tire and thus enabling a vehicle to moved as desired. The present invention improves over the prior art by providing an improved hydraulic system for jacking and dollying a vehicle tire and wheel.

### SUMMARY OF THE INVENTION

It is, thus, an object of this invention to provide an apparatus capable of jacking and dollying a vehicle wheel assembly, the assembly including a pneumatic tire, wheel and axle, while the assembly remains affixed to the vehicle, and which is utilized with a hydraulic activation system.

It is a further object of this invention to provide an apparatus capable of jacking and dollying affixed vehicle wheel assemblies which are of varying size by the simple depression of a hydraulic activation system.

It is another object of this invention to provide an apparatus capable of jacking and dollying an affixed vehicle wheel assembly whether the pneumatic tire thereof is inflated or deflated.

It is a still further object of this invention to provide an apparatus for jacking and dollying an affixed vehicle wheel assembly, which apparatus may be simply and quickly manipulated by an operator without the need for cranking or the use of mechanical levers.

It is yet another object of this invention to provide an apparatus capable of jacking and dollying an affixed vehicle wheel assembly, which apparatus is sufficiently compact so as not to encumber vehicle movement.

And, it is a further object of this invention to provide an apparatus capable of jacking and dollying an affixed vehicle wheel assembly, which apparatus is of simple and low cost construction.

The apparatus in accordance with this invention achieves the desired objects by featuring a framework that is formed into a carriage for receiving an affixed vehicle wheel assembly; i.e., pneumatic tire, a wheel and an axle, as the assembly is lifted. The apparatus also features a wheel engaging member and a hydraulic actuator-based outward which cooperates to provide a mechanical advantage capable of lifting the assembly onto the dolly framework whether the wheel assembly tire is inflated or deflated.

In accordance with the invention, the framework is constituted by structure including a body section having a first member slidably received in a second member. The framework includes a first arm attached to the body section first member and a second arm attached to the body section second member. The framework arms are oriented to extend from the body section in a direction approximately orthogonal to the center line of the body section to form a generally “U” shaped structure. Wheel rollers are provided on the apparatus. The wheel engaging rollers including a first element mounted on the framework first arm and a second element mounted at the framework second arm.

The apparatus includes a hydraulic actuator. The hydraulic actuator in accordance with this invention is a simple, single action mechanism coupled to both the body section first and second arm members.

When the hydraulic actuator forces the wheel engaging members against the tread of the pneumatic tire, the tire is positioned between the framework arm members. The arm members include a roller assembly that permits the pneumatic tire to ride onto the roller assembly, thereby lifting the wheel assembly as the wheel engaging means is forced against the tire.

Simultaneously with the lifting of the wheel assembly, the framework is formed into a carriage for receiving the assembly. As the pneumatic tire rides onto the wheel engaging rollers, the framework body section members are drawn into one another and locked in position by the hydraulic actuator, leaving the tire and remainder of the wheel assembly supported by the rollers, the arm members and body section. Wheels in the form of casters, or the like, are provided on the framework to permit subsequent dollying of the wheel assembly once it is supported on the framework.

The hydraulic actuator, in a preferred form, includes a lever mechanism which actuates hydraulic cylinders which are biased outward. When actuated, the hydraulic cylinders and first and second body section members are drawn toward one another and the roller assemblies of the wheels are forced against the pneumatic tire.

The apparatus of this invention overcomes the shortcomings of the prior art by providing a compact and simple mechanism capable of quickly jacking and dollying an affixed wheel assembly, whether inflated of deflated, and without either encumbering vehicle movement or apparatus manufacturing costs, and without mechanical levers or ratchets. It is an object of the present invention to provide a lift and dolly mechanism which incorporates a hydraulic lift mechanism.

The present invention is an apparatus that jacks and dollies a vehicle wheel assembly while the assembly is affixed to the vehicle, the assembly including a pneumatic tire and wheel, an axle, a framework including a body section having a first member and a second member, the first and second members being movable relative to one another, a first arm member connected to the first body member and a second arm member connected to the body section second member; rollers affixed to the first arms for interacting with the wheel assembly, an hydraulic actuator connected to the framework and which cooperates with the arms such that when the hydraulic actuator means is activated, the rollers are forced into contact with the pneumatic tire causing the tire to ride over the rollers and lift the wheel assembly: and transport wheels for rendering the apparatus movable.

In a further embodiment, the invention is an apparatus for jacking and dollying a vehicle wheel assembly while the assembly is affixed to the vehicle, the assembly including a pneumatic tire and a comprising: an apparatus framework including a body having a first member and a second member, the first and second body section members being movable relative to one another, and further including a first arm member connected to the first body section member and a second arm member connected to the body section second member; a roller assembly affixed to each arm which permits the pneumatic tire to ride over the roller assembly as the arms interact with the wheel assembly; and a hydraulic actuator in a biased outward position, which is compressed by a lever to drive the arms first and second elements together with the apparatus framework, for receiving the wheel assembly and which also cooperates with the roller assembly of the engaging means to provide a mechanical advantage for lifting the wheel assembly onto the carriage, the hydraulic actuator including a lever mechanism; and wheels affixed with the framework for rendering the apparatus movable.

The foregoing and other objects, features and advantages of the invention will become apparent from the following more detailed description of its preferred embodiments, as illustrated in the accompanying Figures.

### BRIEF DESCRIPTION OF THE FIGURES

FIG. 1 is an exploded view of the present invention.

FIG. 2 is an exploded view of the hydraulic activator of the invention.

FIG. 3 is an elevational perspective view of the jack dolly of the present invention in operation.

FIGS. 4 and 5 are isolated partial side views of the invention in operation.

### DESCRIPTION OF THE PREFERRED EMBODIMENT

The present invention is described with reference to the enclosed Figures wherein the same numbers are utilized. In a broad embodiment, the present invention is directed to a hydraulic actuated dolly mechanism 10 which raisers and supports the tires of a vehicle off of the ground. It is to be noted that the teachings of the invention are applicable to a wide range of vehicles including cars, trucks, RVs, SUVs, buses, etc.

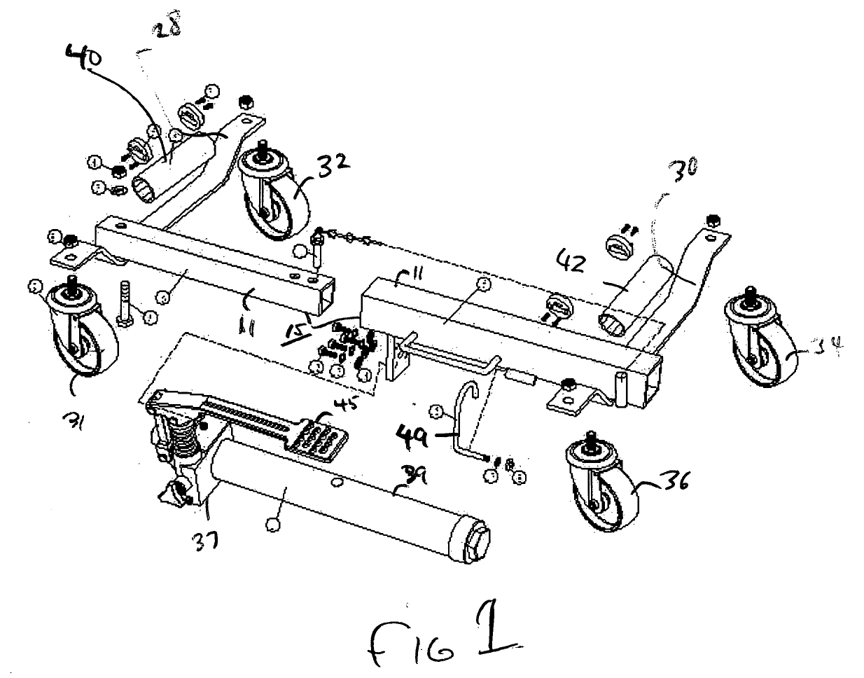

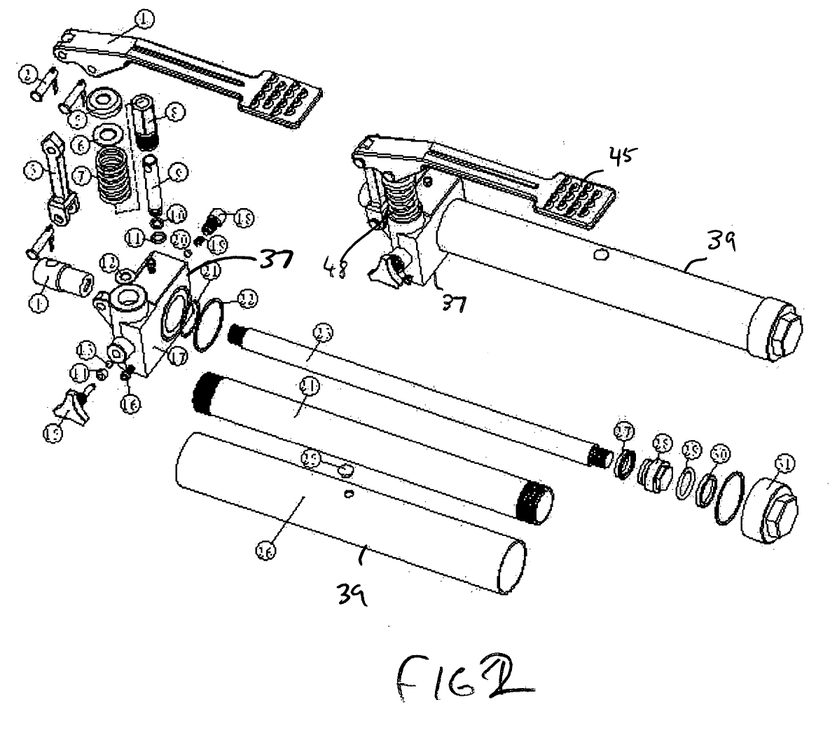

The hydraulic actuated jacking and dollying apparatus of this invention is shown in a first preferred embodiment in FIGS. 1 through 5. As seen in FIG. 1, the apparatus 10 may be positioned compactly about a wheel assembly 12 of a vehicle. The wheel assembly includes a pneumatic tire 12. As shown in FIG. 2, the preferred embodiment of the apparatus 10 features a telescoping framework 11 defining a body section 15 and two arm members 28 and 30 attached thereto.

Body section 15 together with arm members 28 and 30 form a generally “U” shaped frame structure. The framework 11 is provided with wheels or rollers in the form of wheel assemblies 31, 32, 34 and 36 mounted on the framework to facilitate movement of the apparatus as desired. While casters or wheels are shown, it is to be appreciated that other embodiments are envisioned.

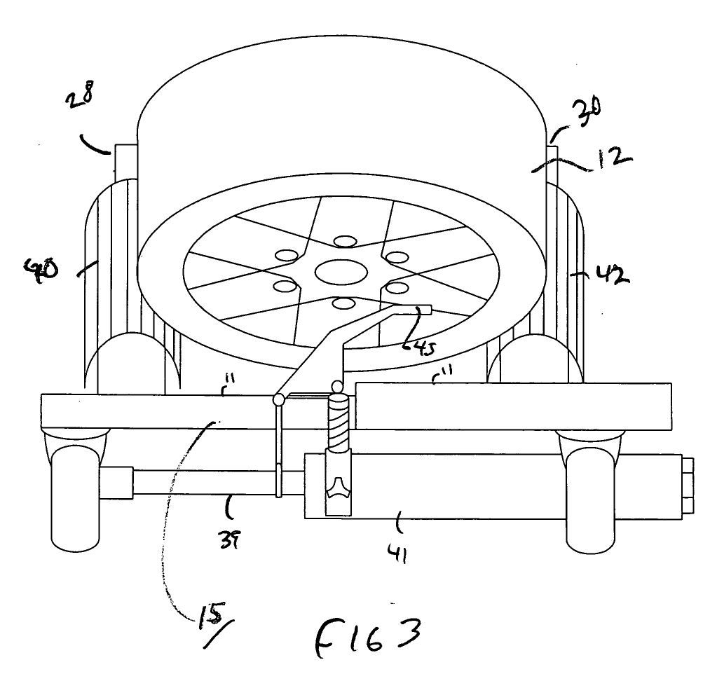

The apparatus 10 also includes wheel engaging systems in the form of rollers 40 and 42 mounted on the arms 28 and 30, respectively. Roller assemblies 40 and 42 are arranged to engage the tire about which apparatus 10 may be positioned as best seen in FIG. 3.

The critical feature of the invention is a hydraulic actuator system. As shown in FIGS. 3 to 5, the actuator mechanism comprises a manifold 37 affixed by a spring loaded 48 lever 45 to hydraulic cylinders 39, 41. The ends of each cylinder 39, 41 are attached to arm members 28, 30. The lever 45, when depressed, causes the cylinders 31, 41 which are biased outwardly to compress. The arm members 28, 30 converge and the tire is thrust upward onto the rollers 40, 42.

The hydraulic actuation system is biased outward such that the arms of the framework 28, 30 are held outwardly. When the lever 45 is actuated and held, the arms 28, 30 move inwardly by the hydraulic cylinder and thus forcing the tire inwardly and upwardly and onto the rollers 40, 42. The lever 45 is then locked in the downward position with the unshaped catch 49. When the vehicle is to be lowered, the lever is unlocked in the upward position and the arms separate move outwardly, thus permitting the tires to roll off of the system via the rollers 40, 42.

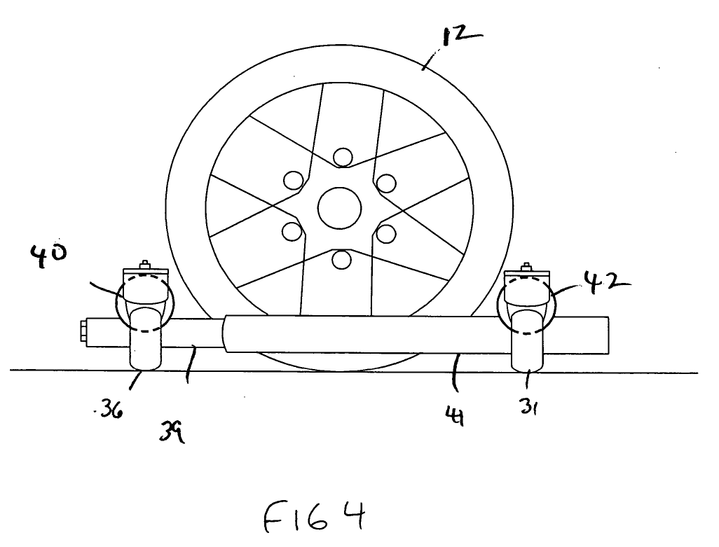

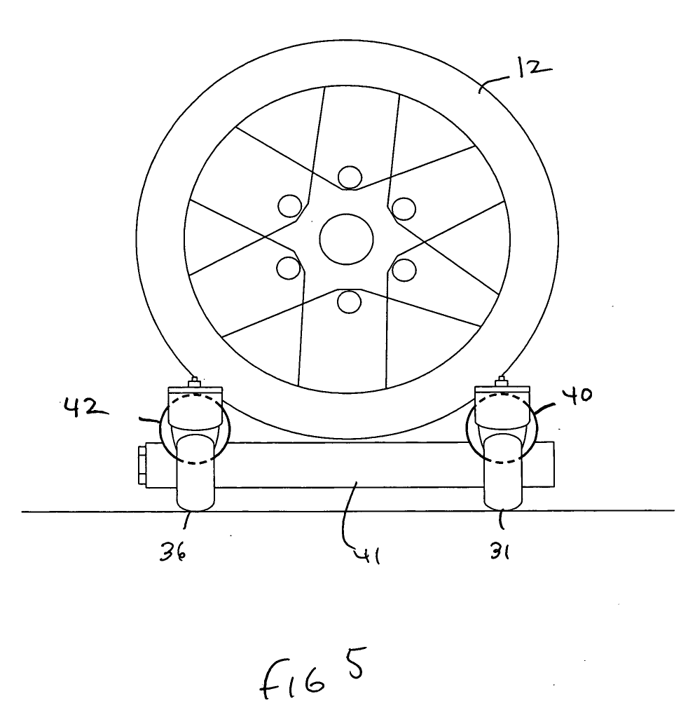

Referring to FIGS. 4 and 5, in operation, preferably four of the dollies 10 of the present invention are placed proximate to the four tires of a vehicle. The arms 28, 30 and roller mechanisms 40, 42 are placed on opposing sides of each tire 14. The lever 45 is depressed, thus causing the outwardly biased hydraulic cylinders 39, 41 to compress, thus forcing the tires on each roller pair 40, 42.

The lever 45 is then locked downwardly with catch 49 maintaining the system in a closed position. The vehicle and four wheels, each on a dolly, can be moved as desired. When it is desired to release the vehicle, the lever 45 is unlatched and the arms 28, 30 move outwardly as the cylinders expand, releasing the wheels.

The present invention has been described with reference to the above discussed preferred embodiment. It is to be appreciated that the true nature and scope of the present invention is to be determined with reference to the claims appended hereto.

1. An apparatus that jacks and dollies a vehicle wheel assembly while the assembly is affixed to the vehicle, the assembly including a pneumatic tire and wheel, an axle,
a framework including a body section having a first member and a second member, the first and second members being movable relative to one another,
a first arm member connected to the first body member, and a second arm member connected to the body section second member;
rollers affixed to the first arms for interacting with the wheel assembly,
an hydraulic actuator connected to the framework and which cooperates with the arms such that when the hydraulic actuator is activated, the rollers are forced into contact with the pneumatic tire causing the tire to ride over the rollers and lift the wheel assembly; and
transport wheels for rendering the apparatus movable.

2. The apparatus of claim 1 wherein the transport wheels includes a plurality of casters mounted on the framework.

3. The apparatus of claim 1 wherein the hydraulic actuator is a lever activated mechanism having at least a lever element in which the depression of the lever closes the arms and lifts the tire.

4. Apparatus for jacking and dollying a vehicle wheel assembly while the assembly is affixed to the vehicle, the assembly including a pneumatic tire and a comprising:
an apparatus framework including a body having a first member and a second member, the first and second body section members being movable relative to one another, and further including a first arm member connected to the first body section member and a second arm member connected to the body section second member;
a roller assembly affixed to each arm which permits the pneumatic tire to ride over the roller assembly as the arms interact with the wheel assembly;
a hydraulic actuator in a biased outward position, which is compressed by a lever to drive the arms first and second elements together with the apparatus framework, for receiving the wheel assembly and which also cooperates with the roller assembly of the engaging means to provide a mechanical advantage for lifting the wheel assembly onto the carriage, the hydraulic actuator including a lever mechanism; and
wheels affixed with the framework for rendering the apparatus movable.

5. Apparatus for jacking and dollying a vehicle wheel assembly while the assembly is affixed to the vehicle, the assembly including a pneumatic tire and a comprising:
an apparatus framework including a body having a first member and a second member, the first and second body section members being movable relative to one another, and further including a first arm member connected to the first body section member and a second arm member connected to the body section second member;
a roller assembly affixed to each arm which permits the pneumatic tire to ride over the roller assembly as the arms interact with the wheel assembly;
a hydraulic actuator in a biased outward position, which is compressed by a lever to drive the arms first and second elements together with the apparatus framework, for receiving the wheel assembly and which also cooperates with the roller assembly of the engaging means to provide a mechanical advantage for lifting the wheel assembly onto the carriage, the hydraulic actuator including a lever mechanism;
wheels affixed with the framework for rendering the apparatus movable; and
a catch for holding the lever in a downward position.
